(19) United States
(12) Patent Application Publication
(10) Pub. No.: US 2015/0211374 A1
(43) Pub. Date: Jul. 30, 2015

(54) TURBINE WHEEL

(71) Applicant: BorgWarner Inc., Auburn Hills, MI (US)

(72) Inventor: Igor Koenig, Frankenthal (DE)

(73) Assignee: BorgWarner Inc., Auburn Hills, MI (US)

(21) Appl. No.: 14/425,660

(22) PCT Filed: Sep. 11, 2013
(86) PCT No.: PCT/US2013/059159

§ 371 Date: Mar. 4, 2015

(30) Foreign Application Priority Data
Sep. 19, 2012 (DE) 102012018530.8

(51) Int. Cl. F01D 5/22; F01D 5/04

(52) U.S. Cl. CPC F01D 5/225; F01D 5/048; F05D 2220/40

(57) ABSTRACT

A turbine wheel (4) having a hub (29); a multiplicity of turbine wheel blades (30) arranged around the hub (29); a turbine wheel back wall (31) which is arranged on the hub (29) adjacent to an edge region (32) of the turbine wheel blades (30); wherein the wall thickness (W) of the turbine wheel (4) back wall is reduced in regions.

The invention relates to a turbine wheel as per the preamble of claim 1 and to an exhaust-gas turbocharger as per the preamble of claim 5.

A known turbine wheel has a hub around which a multiplicity of turbine wheel blades are arranged. A turbine wheel back wall is arranged on the hub at an edge region, which in the installed state of the turbine wheel is adjacent to a shaft, of the turbine wheel blades.

It is an object of the present invention to provide a turbine wheel of the type specified in the preamble of claim 1, the mass moment of inertia of which turbine wheel is reduced.

This object is achieved by the features of claim 1.

It is accordingly possible according to invention for the wall thickness of the turbine wheel back wall to be reduced at least in regions.

The dependent claims contain advantageous developments of the inventions.

For the reduction of the wall thickness of the turbine wheel back wall in regions, said turbine wheel back wall may preferably be provided with pockets which are open on one side and which are arranged on that side of the turbine wheel back wall which faces away from the turbine wheel blades.

Said pockets are preferably arranged on the outer diameter of the turbine wheel, between the turbine wheel blades.

The depth of the pockets is dependent on the desired extent of the reduction in mass moment of inertia. In any case, however, the pockets are not formed so as to be continuous, that is to say are not formed so as to extend through the entire wall thickness of the turbine wheel back wall.

The arrangement at the outer diameter or outer circumference of the turbine wheel means that the pockets are arranged at the inlet diameter or inlet circumference of the turbine wheel.

The exhaust-gas turbocharger according to invention defined in claim 5 is provided with a turbine wheel according to the invention.

Further details, advantages and features of the present invention become apparent from the following description of exemplary embodiments with reference to the drawing, in which:

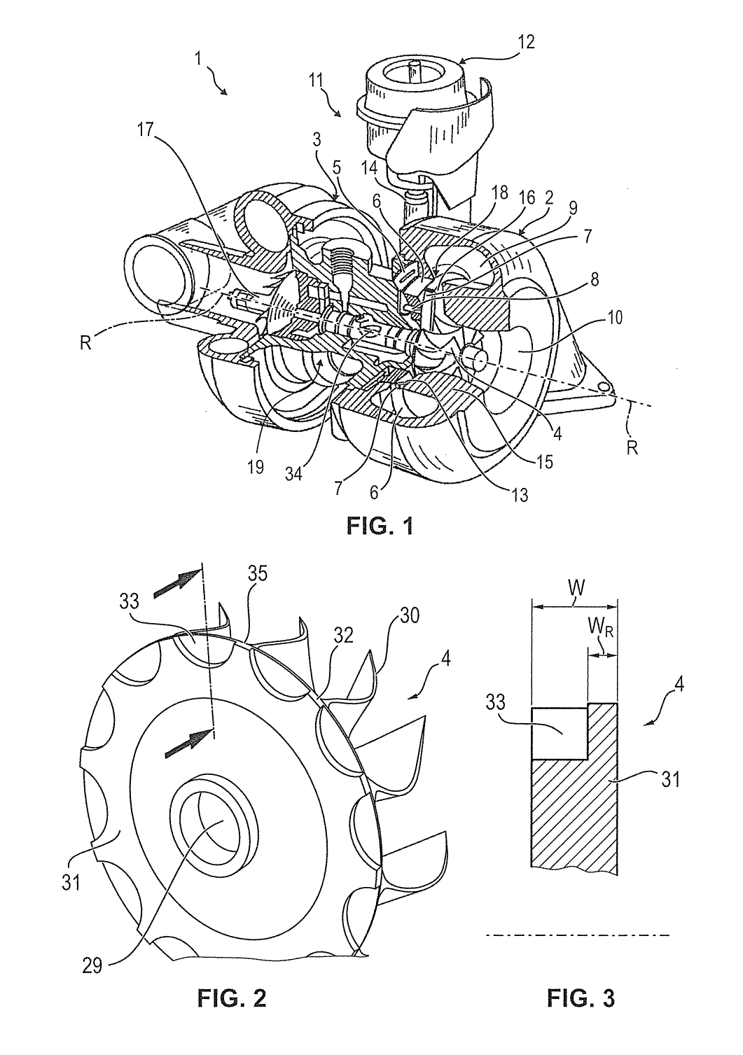

FIG. 1 shows a perspective sectional illustration through an exhaust-gas turbocharger according to the invention,

FIG. 2 shows a perspective illustration of a turbine wheel according to the invention, and

FIG. 3 shows a sectional illustration through a partial region of the turbine wheel as per FIG. 2.

FIG. 1 illustrates an exhaust-gas turbocharger 1 according to the invention which has a turbine housing 2 in which a turbine wheel 4 is arranged.

With regard to all other components of the exhaust-gas turbocharger 1 according to the invention, reference may be made to the list of reference signs provided at the end of this description, because a detailed description of said elements is not important for explaining the principles of the present invention.

The turbine wheel 4 according the invention is illustrated in FIG. 2. Said turbine wheel 4 has a hub 29 around which are arranged a multiplicity of turbine wheel blades, of which, in FIG. 2, one turbine wheel blade is identified, representatively of all of the blades, by the reference sign 30.

The turbine wheel 4 furthermore has a turbine wheel back wall 31 which is arranged on the hub 29 at an edge region 32 of the turbine wheel blades 30. As shown by FIG. 2 in conjunction with FIG. 1, the edge region 32 is that region which, in the installed state of the turbine wheel 4, faces toward a shaft 34, to which shaft the turbine wheel 4 is fastened, of the exhaust-gas turbocharger 1.

As can be seen viewing FIGS. 2 and 3 together, for the reduction of the wall thickness W of the turbine wheel back wall 31 in regions, it is provided in the example that a multiplicity of pockets which are open on one side are arranged in the turbine wheel back wall 31, of which pockets one pocket 33 is denoted, representatively of all of the pockets, in FIGS. 2 and 3. The pockets 33 may be of various forms, for example semi-circular, and do not extend through the entire wall thickness W, as can be seen from the reduced wall thickness WR, indicated in FIG. 3, in the region of the pockets 33.

The pockets 33 are furthermore arranged at the outer circumference (inlet circumference) 35 of the turbine wheel 4 or of the turbine wheel back wall 31.

The number of pockets 33, and also the depth thereof in the wall thickness W of the turbine wheel back wall 31, may be reduced or increased depending on the application.

In addition to the above written disclosure of the invention, reference is hereby explicitly made to the illustrative presentation of the invention in FIGS. 1 to 3.

### LIST OF REFERENCE SIGNS

1 Turbocharger

2 Turbine housing

3 Compressor housing

4 Turbine wheel

5 Unison ring

6 Blade bearing ring

7 Adjusting blades

8 Rotary axles

9 Supply duct

10 Axial connector

11 Actuating device

12 Control casing

13 Free space for adjusting blades 7

14 Plunger element

15 Annular part of the turbine housing 2

16 Spacer/spacer cam

17 Compressor wheel

18 Guide grate

28 Bearing housing

29 Hub

30 Turbine wheel blades

31 Turbine wheel back wall

32 Edge

33 Pockets

34 Shaft

W Wall thickness of the turbine wheel back wall

W_{R} Reduced wall thickness

R Axis of rotation

1. A turbine wheel (4) having
a hub (29) including a radially enlarged disc-like portion of the hub, the disk-like portion defining a floor on one side and a back wall (31) on the other side; and
a multiplicity of turbine wheel blades (30) arranged around the hub (29);
wherein
the wall thickness (W) of the radially enlarged disc-like portion of the hub is reduced in regions adjacent to an edge region (32) of the turbine wheel.

2. The turbine wheel as claimed in claim 1, wherein the turbine wheel back wall (31) has at least one pocket (33) which is open on one side.

3. The turbine wheel as claimed in claim 2, wherein the pocket or the pockets (33) are arranged on the inlet circumference (35) of the turbine wheel back wall (31).

4. The turbine wheel as claimed in claim 2, wherein the pocket or the pockets (33) do not extend through the entire wall thickness (W) of the turbine wheel back wall (31).

5. An exhaust-gas turbocharger (1)
having a turbine housing (2) in which is arranged a turbine wheel (4) which has:
a hub (29);
a multiplicity of turbine wheel blades (30) arranged around the hub (29), and
a turbine wheel back wall (31) which is arranged on the hub (29) adjacent to an edge region (32) of the turbine wheel blades (30),
wherein
the wall thickness (W) of the turbine wheel back wall (31) is reduced in regions.

6. The exhaust-gas turbocharger as claimed in claim 5, wherein the turbine wheel back wall (31) has at least one pocket (33) which is open on one side.

7. The exhaust-gas turbocharger as claimed in claim 5, wherein the pocket or the pockets (33) are arranged on the circumference (35) of the turbine wheel back wall (31).

8. The exhaust-gas turbocharger as claimed in claim 5, wherein the pocket or the pockets (33) do not extend through the entire wall thickness (W) of the turbine wheel back wall (31).
